(19) United States
(12) Patent Application Publication
(10) Pub. No.: US 2017/0017863 A1
(43) Pub. Date: Jan. 19, 2017

(54) SYSTEMS AND METHODS FOR CORRECTING UNDERLAP AND OVERLAP IN PRINTING OPERATIONS

(71) Applicants: Robert W. Martell, Portland, OR (US); Kevin M. Parks, Canby, OR (US)

(72) Inventors: Robert W. Martell, Portland, OR (US); Kevin M. Parks, Canby, OR (US)

(21) Appl. No.: 14/798,758

(22) Filed: Jul. 14, 2015

(51) Int. Cl. G06K 15/02

(52) U.S. Cl. CPC G06K 15/027

(57) ABSTRACT

Printing systems including a printing mechanism for printing adjacent print passes and a computing system are shown and described. Memory of the computing system includes computer-readable instructions for: receiving calibration data; receiving graphical data having first and second sets of perimeter graphical data; generating a first set of longitudinal boundary graphical data based on the first set of perimeter graphical data and the calibration data; generating a second set of longitudinal boundary graphical data based on the second set of perimeter graphical data and the calibration data; printing a first print pass having a first perimeter print area and a first longitudinal boundary area; printing a second print pass having a second perimeter print and a second longitudinal boundary area; and blending the first and the second longitudinal boundary areas to generate an at least partially overlapping longitudinal boundary area.

### BACKGROUND

The present disclosure relates generally to printing systems and methods for correcting underlap and overlap in a printing operation. In particular, printing systems and methods that correct underlap and overlap in a printing operation based on perimeter print area data are described.

Known printing systems are not entirely satisfactory for the range of applications in which they are employed. For example, existing printing systems, repeated use of printing machinery causes wear, warping, offsetting, and/or misalignment of the printing machinery. As a result, printing of adjacent print passes during a printing operation can include one or more of underlap (i.e., gapping or white space) or overlap (i.e., over saturation) in the image produced by the printing operation. In addition, conventional printing systems and methods require adjustment and/or replacement of the printer components (i.e., machinery) in order to correct for underlap and/or overlap.

Thus, there exists a need for printing systems and methods that improve upon and advance the design of known printing systems. Examples of new and useful printing systems and methods relevant to the needs existing in the field are discussed below.

### SUMMARY

The present disclosure is directed to printing systems having a printing mechanism and a computing system. The printing mechanism is capable of making a plurality of adjacent print passes having overlapping boundary areas on a printing substrate. Memory of the computing system includes computer-readable instructions for: receiving calibration data; receiving graphical data having a first set of perimeter graphical data and a second set of perimeter graphical data; generating a first set of longitudinal boundary graphical data according to the first set of perimeter graphical data and the calibration data; generating a second set of longitudinal boundary graphical data according to the second set of perimeter graphical data and the calibration data; printing a first print pass on the printing substrate, the first pass having a first perimeter print area and a first longitudinal boundary area; printing a second print pass on the printing substrate having a second perimeter print and a second longitudinal boundary area; and blending the first longitudinal boundary area and the second longitudinal boundary area to generate an at least partially overlapping longitudinal boundary area.

### BRIEF DESCRIPTION OF THE DRAWINGS

FIG. 1 shows a schematic view of an example of a programmable computing device.

FIG. 2 is a perspective view of a first example printer in a closed position.

FIG. 3 is a front elevation view of the first example printer in an open position.

FIG. 4 is a schematic view of a first example print pass.

FIG. 5 is a schematic view a first example printing operation including the first example print pass shown in FIG. 4.

FIG. 6 is a schematic view of a first example data set for the first example printing pass shown in FIG. 4.

FIG. 7 is a schematic view of a second example data set for the first example printing pass shown in FIG. 4.

FIG. 8 is a schematic view of a third example data set for the first example printing pass shown in FIG. 4.

FIG. 9 is a flow chart of an example method for using the printing system shown in FIGS. 1-3.

### DETAILED DESCRIPTION

The disclosed printing systems and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various printing systems and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

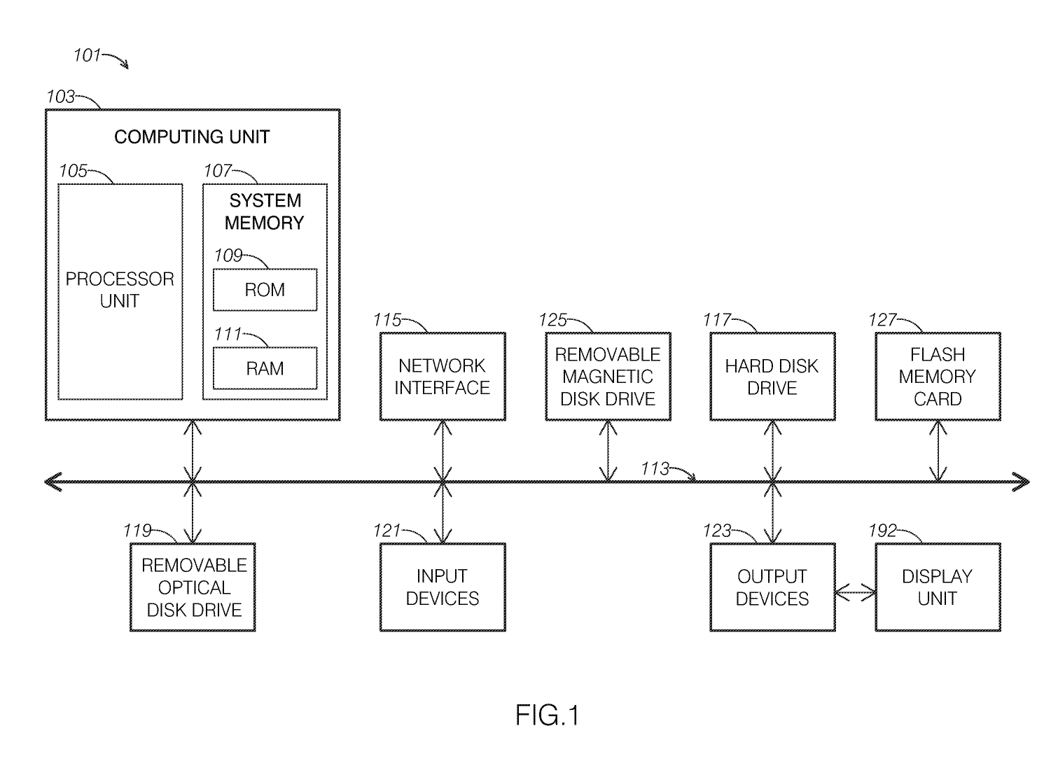

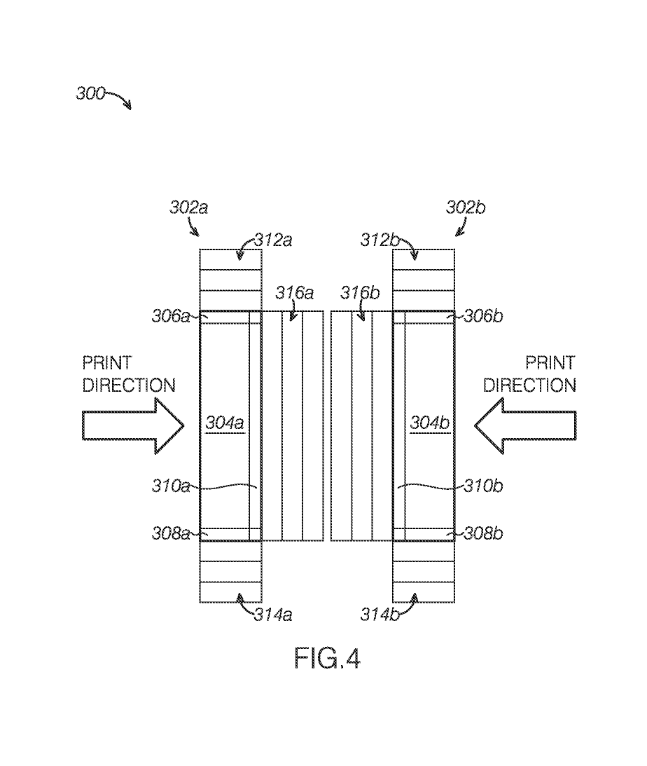

With reference to FIGS. 1-8, a first example of a printing system, printing system 100, will now be described. As shown in FIGS. 1-3, printing system 100 includes a computer 101 in data communication with a printer 200. Printing system 100 functions to allow correction of underlap between adjacent print passes in a printed image. Additionally or alternatively, printing system 100 can be used to correct overlap between adjacent print passes in a printed image. FIGS. 4-8 show examples print passes demonstrating example methods for correcting underlap and/or overlap during a printing operation.

Printing system 100 addresses many of the issues identified with existing printing systems. For example, printing system 100 allows printing of an even and/or smooth image (i.e., an image with limited underlap and/or overlap between adjacent print passes). In another example, printing system 100 can correct for underlap and/or overlap without costly and time consuming adjustment or replacement of printer components.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions (i.e., non-transitory computer-readable instructions stored in a computer-readable storage medium), or by some combination of purpose-specific electronic circuitry and firmware or software instructions executing on a programmable computing device.

Accordingly, FIG. 1 shows one illustrative example of a computer, computer 101, which can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according to the various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

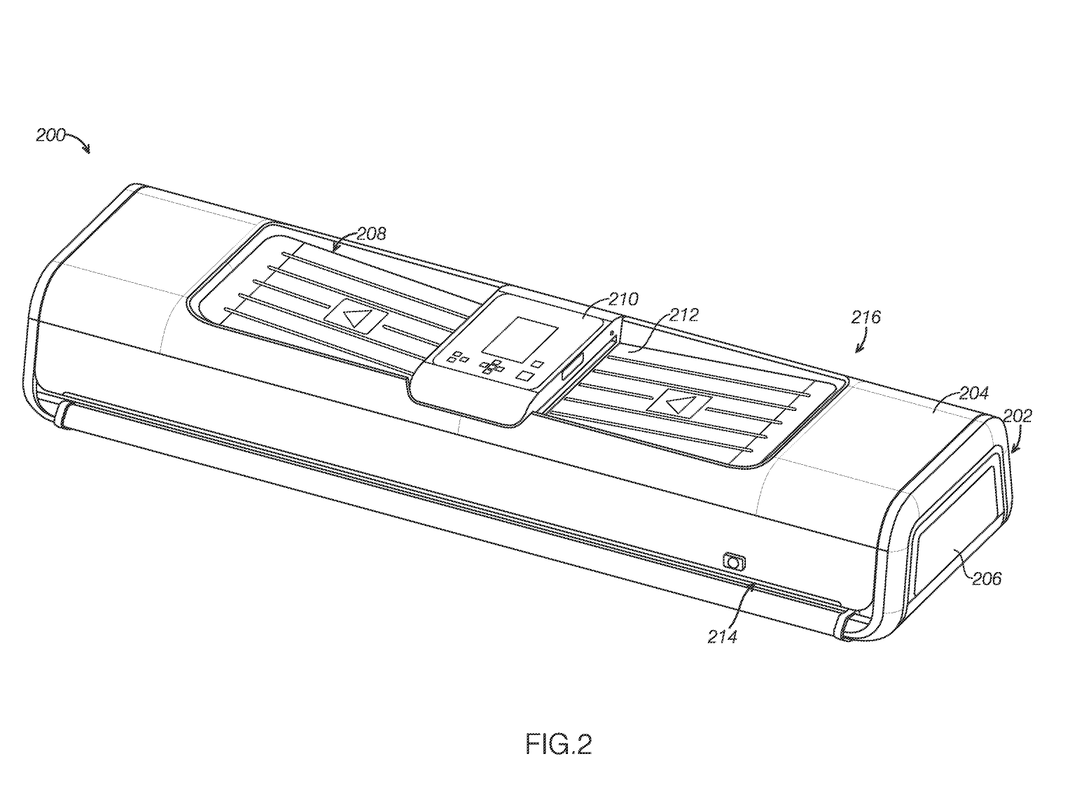

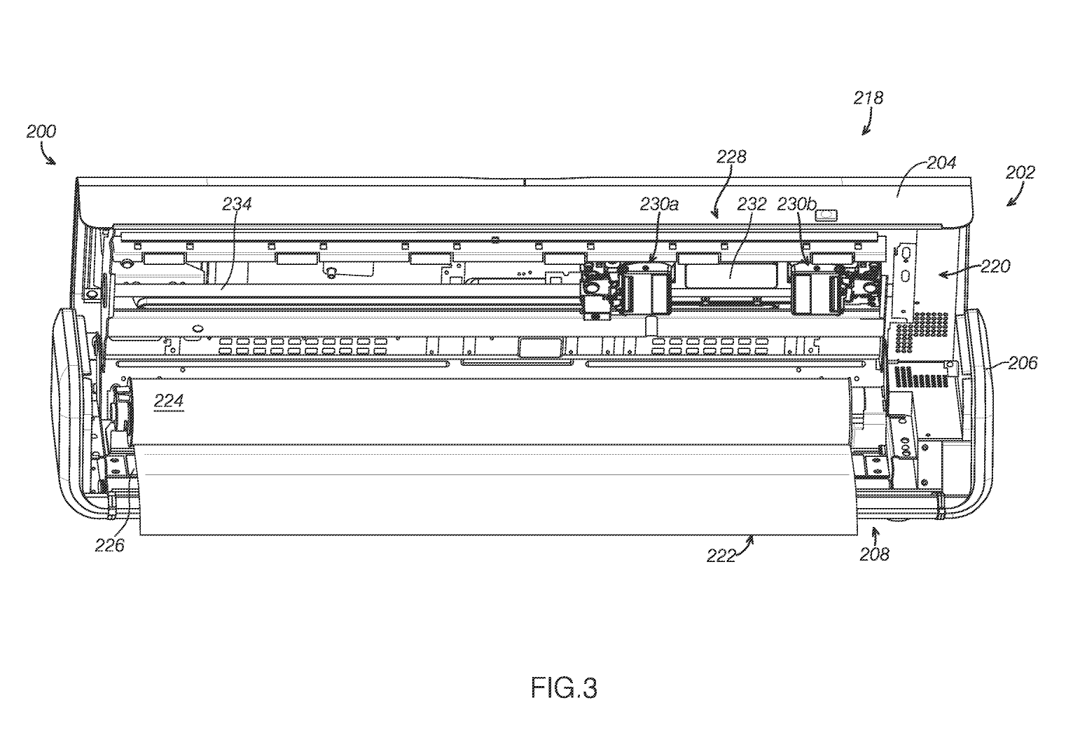

Turning to FIGS. 2 and 3, a first example of a printer, printer 200, will now be described. Printer 200 includes a printer main body 202 for housing a printer head shuttle system 228 having two printer head assemblies 230 (i.e., 230a and 230b) and a printable substrate 222. Printing system 200 functions to transfer or otherwise print a graphic and/or text image onto the printing substrate in a printing operation. In some examples, printing system 200 can be used for alternating operation of printer head assemblies 230 (i.e., 230a and 230b) during a printing operation. In other examples, printing system 100 can be used for simultaneous operation of printer head assemblies 230 (i.e., 230a and 230b) during a printing operation.

As can be seen in FIGS. 2 and 3, printer main body 202 includes a printer lid 204 that is selectively rotatable to cover a printer base 206. An exterior surface 208 of printer lid 204 includes a control panel 210 and a master paper tray 212. A feed space 214 between lip edges of lid 204 and base 106 is a substrate feed for printing substrate 222. In alternate examples the control panel can be eliminated and computer 101 can be used to control printer 200. In even other alternate examples, computer 101 can be integrated into printer 200.

In FIG. 2, lid 204 is in a closed position 216, while FIG. 3 depicts lid 204 in an open position 218. It will be appreciated that the lid is selectively pivotable between the closed position and the open position via a pivotable attachment mechanism (not specifically shown). As shown in FIG. 3, an interior surface 220 of lid 204 includes a printer head shuttle system 228 having a shuttle main body 232 that is moveable along a shuttle guide 234. Printer head assemblies 230a and 230b (i.e., printing mechanisms) are attached to opposing longitudinal ends of the shuttle main body. In other examples, the shuttle main body can include a single printer head. Also shown in FIG. 3, a roll 224 of printing substrate 222 is located inside printer main body 202 and is supported on a platen 226 as it is unrolled during a printing operation.

The shuttle main body is configured for backward and forward movement across the shuttle guide. During a printing operation, the lid is in the closed position and the printer head shuttle moves forward and backward along the shuttle guide. The printer head assemblies are proximal to and/or contact the printing substrate and move across the surface of the printing substrate as the shuttle guide moves forward and backward along the shuttle guide. Accordingly, a plurality of print passes are printed on a printing substrate in order to produce an image on the printing substrate. The printing substrate is incrementally fed through the feed space as it is printed upon and the printing substrate is supported by the platen. It will be appreciated that printer 200 can be an ink printer, a thermal printer, a dye-sublimation printer, or another other type of printer known or yet to be discovered.

Printer 200 is in data communication with computer 101 for receiving graphical data from the computer and/or the user. Accordingly, computer 101 can be used to provide instructions for controlling the printer head assemblies during a printing operation. In the present example, printer 200 is in wireless data communication with computer 101. In other examples, printer 200 can include one or more wires for data communication with computer 101.

As described above, with use over time, components of printer 200 can undergo wear, warping, offsetting, and/or misalignments. Computer 101 is configured to receive printer calibration information for printer 200 from a user. In alternate examples, the computer and the printer can include sensors for automatically detecting and calculating calibration information for the printer components. Further, computer 101 is configured to receive other printing operation parameters, such as a desired printing operation speed, a desired accuracy, a printing substrate feed rate, a print head travel speed, etc.

Based on the input and/or detected calibration data and other printing operation parameters, computer 101 sends instructions (i.e., graphical data) to printer 200 for printing main print areas (i.e., central print areas), perimeter print areas, and overlapping boundary areas (i.e., overlapping areas between adjacent print passes in a printing operation). Graphical data can include binary pixel data (i.e., 0 and 1) for pixel positions within the main print areas, the perimeter print areas, and the overlapping boundary areas. In some examples, where printer 200 is a thermal printer, graphical data can further include intensity data for each pixel position.

In other words, the computer includes a non-transitory computer-readable storage medium having computer-readable instructions for: receiving calibration data, receiving graphical data including perimeter graphical data and main print area graphical data, generating boundary graphical data based on the perimeter graphical data and the calibration data, printing a perimeter print area corresponding to the perimeter graphical data, printing a main print area corresponding to the main print area graphical data, and printing boundary print area corresponding to the generated boundary graphical data.

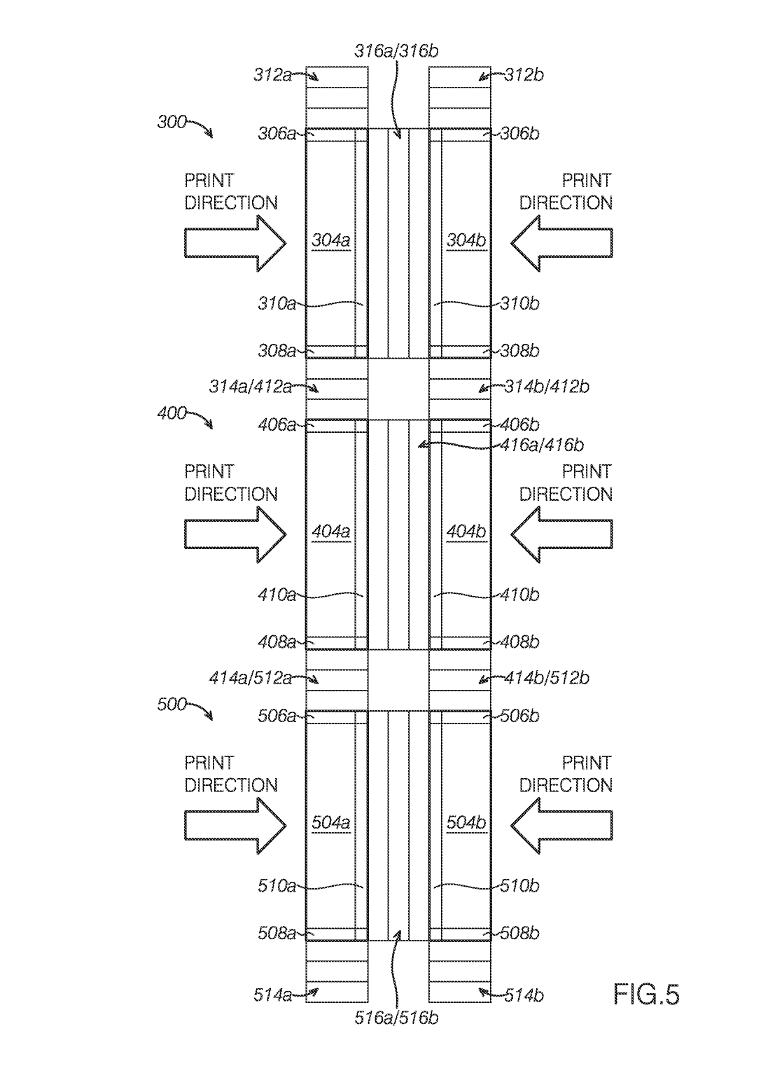

FIGS. 4 and 5 show schematic views of printing passes that can be printed by printer 200. Specifically, FIG. 4 shows a first print pass 300 including a left side partial pass 302a and a right side partial pass 302b. It will be appreciated that left side pass 302a can be executed/printed by printer head assembly 230a, while right side pass 302b can be printed by printer head assembly 230b. In the present example, each of the partial print passes traverses substantially one half of the desired print area of the printing substrate. In other examples, where a printer has a single printing mechanism, the printing pass can include a single printing pass that traverses the desired print area of the printing substrate. In even other examples, where a printer has more than two printing mechanisms, the print pass can include a corresponding number of partial print passes.

In the present example, partial print passes 302a and 302b are printed in opposing directions. In other examples, the partial print passes can be printed in the same direction. Each of partial print passes 302a and 302b includes a main print area 304a and 304b, respectively. Main print area 304a has a first longitudinal perimeter print area 306a, a second longitudinal perimeter print area 308a, and a lateral perimeter print area 310a. Similarly, main print area 304b has a first longitudinal perimeter print area 306b, a second longitudinal perimeter print area 308b, and a lateral perimeter print area 310b.

Boundary print areas lie outside of the main print areas, adjacent to the perimeter print areas. Specifically, a first longitudinal boundary print area 312a is adjacent to longitudinal perimeter print area 306a, a second longitudinal boundary print area 314a is adjacent to perimeter print area 308a, a lateral boundary print area 316a is adjacent to lateral perimeter print area 310a, a first longitudinal boundary print area 312b is adjacent to longitudinal perimeter print area 306b, a second longitudinal boundary print area 314b is adjacent to perimeter print area 308b, a lateral boundary print area 316b is adjacent to lateral perimeter print area 310b.

FIG. 4 shows a non-overlapping view of printing pass 300. In the present example, each of the perimeter print areas is a single pixel position width, while each of the boundary print areas has a three pixel position width. It will be appreciated that in alternate examples a width of either of the perimeter print areas and the boundary print areas can include more pixel positions. Further, in other alternate examples, the width of the boundary print areas can include fewer pixel positions.

FIG. 5 shows an over-lapping view of printing pass 300 in combination with two other printing passes, printing pass 400 and printing pass 500. Printing passes 400 and 500 include substantially similar or identical features to printing pass 300. Thus, for the sake of brevity, each feature of printing passes 400 and 500 will not be redundantly explained and the reader should reference the discussion above for features substantially similar between the various printing passes. Further, it will be appreciated that a printing passes 300, 400, and 500 are example printing passes in a plurality of print passes to create an image in a printing operation.

Specifically, print areas 400 and 500 include main print areas (404a, 404b and 510a, 510b, respectively), longitudinal perimeter print areas (406a, 406b, 408a, 408b and 506a, 506b, 508a, 508b, respectively), lateral boundary areas (410a, 410b and 510a, 510b, respectively), longitudinal boundary print areas (4122a, 412b, 414a, 414b and 512a, 512b, 514a, 514b, respectively), and lateral boundary print areas (416a, 416b and 516a, 516b, respectively). It will be appreciated that the various areas of print areas 400 and 500 are substantially similar and correspond to those of print area 300 described above.

As depicted in FIG. 5, print areas 300, 400, and 500 are adjacent print passes. Main print areas 304a, 404a, and 504a (along with their respective boundary print areas) are printed by a first printer head assembly, such as printer head assembly 230a, while main print areas 304b, 404b, and 505b (along with their respective boundary print areas) are printed by a second printer head assembly, such as printer head assembly 230b. Accordingly, adjacent longitudinal and lateral boundary areas are overlapping boundary areas in a print operation. For example, FIG. 5 shows overlapping lateral boundary areas 316a/316b, 416a/416b, and 516a/516b. In another example, FIG. 5 shows overlapping longitudinal boundary areas 314a/412a, 314b/412b, 414a/512a, and 414b/512b.

In the present example, longitudinal boundary areas 312a, 312b, 514a, and 514b are non-overlapping boundary areas as they are located at the top and the bottom periphery of the printing operation (i.e., the resulting print image). It will be appreciated that in other examples the print image can include more print passes with corresponding overlapping boundary areas between adjacent print passes (e.g., longitudinal boundary areas 312a, 312b, 514a, and 514b overlapping with adjacent longitudinal boundary areas).

As described above, printing system 100 functions to allow correction of underlap and/or overlap between adjacent print passes in a printed image. More specifically, printing system 100 is capable of receiving calibration data from the user and/or from calibration sensors. Additionally or alternatively, printing system 100 can receive desired printing parameters (e.g., print accuracy, printing speed, etc.) from the user. Based on the calibration data and/or desired printing parameters, printing system 100 is capable of adjusting the graphical data corresponding to the boundary print areas. For example, in a condition where calibration data and/or printing parameters indicate overlap may occur between adjacent print passes, graphical data for the boundary print areas can include a decreased amount of print data. In another example, in a condition where calibration data and/or printing parameters indicate underlap may occur between adjacent print passes, graphical data for the boundary print areas can include an increased amount of print data.

Graphical data for the boundary print areas is generated/calculated according to graphical data for the perimeter of the main print area. Looking at FIG. 5, in a condition of overlap, the computer can decrease the graphical data to be printed in the boundary print areas. For example, in a condition of a higher degree of overlap, the longitudinal boundary areas (312a, 312b, 314a, 314b, 412a, 412b, 414a, 414b, 512a, 512b, 514a, and 514b) and the lateral boundary areas (316a, 316b, 416a, 416b, 516a, and 516b) can include no graphical data. In other words, the boundary areas can be blank pixel positions having no printed image. In other examples, with a lesser degree of overlap, the boundary areas can include a decreased number of printed pixels. In other words, the boundary areas can include some printed graphical data. Alternatively, in a condition of underlap, graphical data printed in boundary print areas can increased to blend and/or feather the edges of the printing pass so that underlap is not apparent between adjacent print passes.

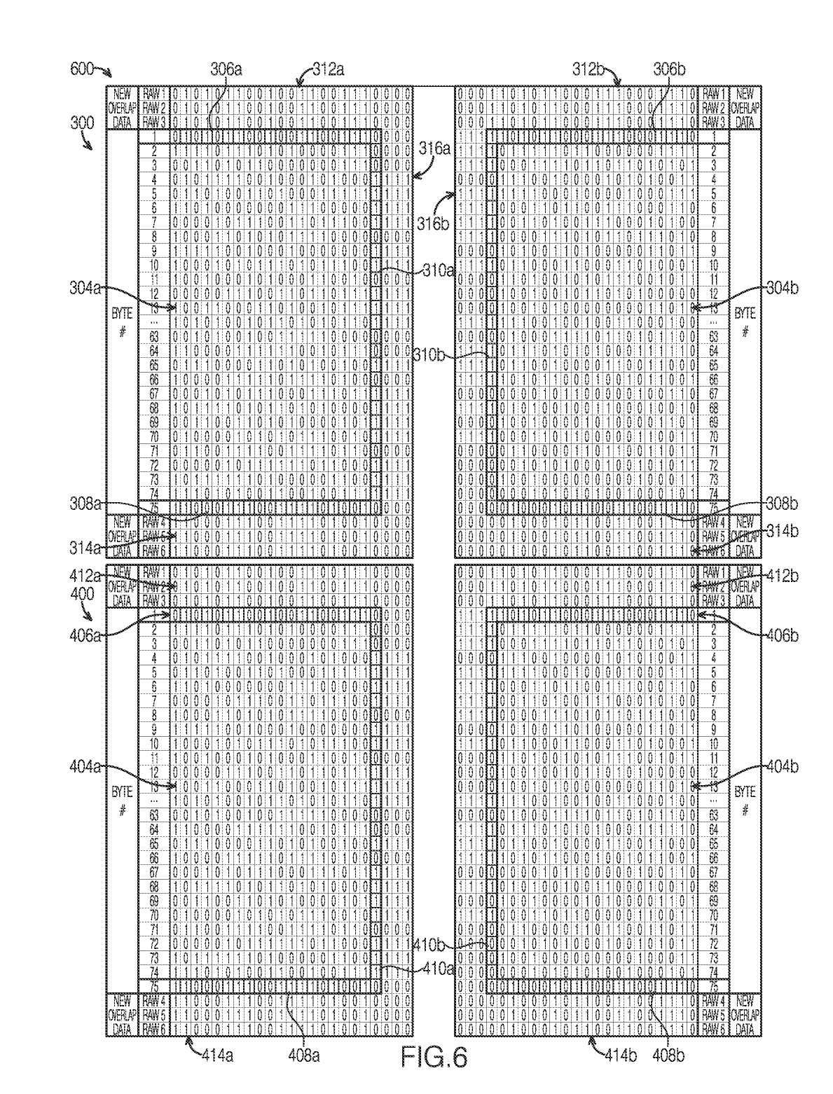

FIGS. 6-8 show specific examples of graphical data (i.e., 600, 700, and 800) for main print areas, perimeter print areas, and boundary print areas for two adjacent print passes (i.e., 300 and 400). The graphical data is shown as a grid, where each increment or square of the grid represents one example pixel position. Further, graphical data is shown in a binary representation, where a “0” represents a non-printed pixel and “1” indicates a printed pixel.

In the present example, the perimeter print areas are one row/column of pixel positions while the boundary print areas are three rows/columns of pixel positions. It will be appreciated that in other examples the perimeter print areas and/or the boundary print areas can include more rows/column of pixel positions. Further, in other alternate examples, the boundary print areas can include fewer rows/columns of pixel positions. In even other alternate examples graphical data can be stored, calculated, and/or represented in a form other than binary pixel position data. It will be further appreciated that graphical data can be stored, calculated, and/or represented in any known or yet to be discovered data format.

FIG. 6 shows graphical data for a first example print operation 600 including first print pass 300 and second print pass 400. In the example of FIG. 6, perimeter graphical data shown in perimeter print areas is directly and/or identically replicated in each of the row/columns of boundary print area pixel positions aligned with the perimeter pixel positions.

Specifically, in one example, longitudinal perimeter print area 308a includes graphical data “11000111001111010010”. The graphical data shown in longitudinal perimeter print area 308a is replicated (i.e., the number of pixels to be printed is copied) in the three rows of pixel positions in longitudinal boundary area 314a. Accordingly, each row of pixel positions in boundary area 314a includes identical graphical data to the perimeter print area 308a (i.e., “11000111001111010010”).

In another example shown in FIG. 6, longitudinal perimeter print area 406a includes graphical data “01010110010011001110”. The graphical data shown in longitudinal perimeter print area 406a is replicated in the three rows of pixel positions in longitudinal boundary area 412a. Accordingly, each row of pixel positions in boundary area 412a includes identical graphical data to the perimeter print area 406a, “01010110010011001110”.

In some examples, the pixels of the perimeter print areas are printed at a substantially similar intensity (i.e., coloration) in the boundary print area. In alternate examples, where printing system 100 includes a thermal printer, the pixels of the perimeter boundary area can be copied at outwardly decreasing intensities, thereby outwardly feathering the boundary print area. It will be appreciated that although not specifically described, graphical data for other boundary print areas of print operation 600 is generated in a substantially similar matter as described above in reference to boundary print areas 314a and 412a.

In the example of graphical data for print operation 600, longitudinal boundary areas 314a and 412a are overlapping longitudinal boundary areas that include replicated perimeter print area graphical data. Therefore, the perimeter graphical data and resulting image is copied a three pixel width distance outside of the main print area. Accordingly, a condition of underlap can be corrected via print operation 600 and graphical data of print operation 600 results from a calculation carried out by computer 101 when printing system 100 is calibrated for a higher degree of underlap.

For other conditions, it may be desirable to decrease the graphical data copied and/or replicated in the boundary print areas. For example, calibration data may indicate a lesser degree of underlap for the printing system. In another example, it may be desirable to have a higher printing and/or processing speed. In these examples, perimeter print area graphical data can be replicated in the boundary print areas at selected intervals. In other words, a portion of the perimeter print area graphical data can be replicated at regular intervals, while the remaining perimeter print area graphical data is non-replicated. It will be appreciated that replicated data can be copied at any desired interval (e.g., every other pixel position, every third pixel position, every fourth pixel position, etc.).

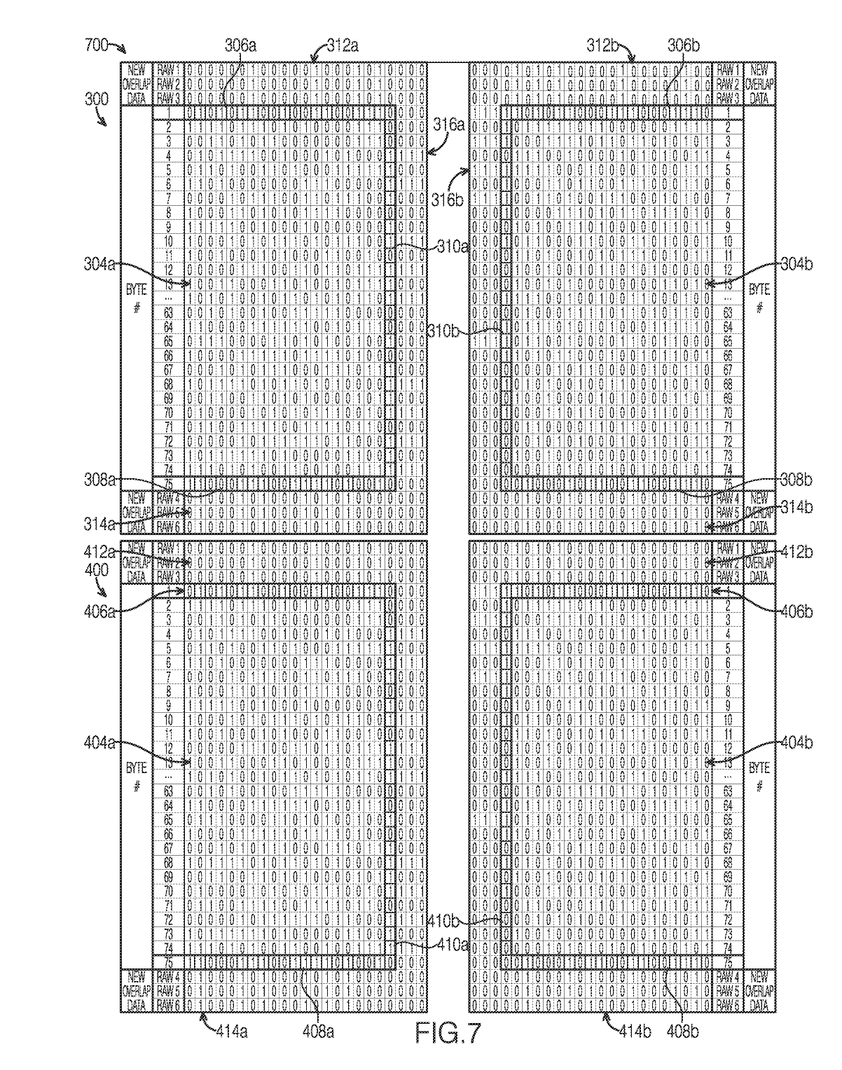

FIG. 7 shows graphical data for a second example print operation 700 where perimeter print area graphical data is replicated at a selected interval. Similarly to print operation 600, print operation 700 includes first print pass 300 and second print pass 400. Differently from print operation 600, in the example of FIG. 7, perimeter graphical data in perimeter print areas is not directly replicated in each of the row/columns of boundary print area pixel positions aligned with the perimeter pixel positions. Instead, perimeter graphical data for every other perimeter pixel position is directly replicated in the corresponding rows/columns of boundary print area pixel positions aligned with the perimeter pixel positions.

Specifically, in one example, longitudinal perimeter print area 308a includes graphical data “110001110011111010010”. The graphical data shown in longitudinal perimeter print area 308a is replicated for every other pixel position in the corresponding three rows of pixel positions in longitudinal boundary area 314a. Non-replicated pixel positions are automatically assigned a “0”. Accordingly, each row of pixel positions in boundary area 314a includes graphical data identical in every other pixel position to the perimeter print area 308a (i.e., “01000101000101010000”). In the present example, the first pixel position is a non-replicated position. It will be appreciated that in other examples the first position can instead be a replicated position, resulting in boundary area graphical data “1000001000101000001”.

In another example shown in FIG. 7, longitudinal perimeter print area 406a includes graphical data “01010110010011001110”. The graphical data shown in longitudinal perimeter print area 406a is replicated in the three rows of pixel positions in longitudinal boundary area 412a. Accordingly, each row of pixel positions in boundary area 412a includes graphical data identical in every other pixel position to the perimeter print area 406a, “00000010000010001010”. In the present example, the first pixel position is a replicated position. It will be appreciated that in other examples the first position can instead be a non-replicated position, resulting in boundary area graphical data “01010100010001000100”.

In some examples, the pixels of the perimeter print areas are printed at a substantially similar intensity (i.e., coloration) in the boundary print area. In alternate examples, where printing system 100 includes a thermal printer, the pixels of the perimeter boundary area pixels can be printed at outwardly decreasing intensities, thereby outwardly feathering the boundary print area. It will be appreciated that although not specifically described, graphical data for other boundary print areas of print operation 700 is generated in a substantially similar matter as described above in reference to boundary print areas 314a and 412a.

In the example of the graphical data for print operation 700, longitudinal boundary areas 314a and 412a are overlapping longitudinal boundary areas that include replicated perimeter print area graphical data. Therefore, the perimeter graphical data and resulting image is alternatingly replicated a three pixel width distance outside of the main print area. Accordingly, a condition of underlap can be corrected via print operation 700 and the graphical data of print operation 700 results from a calculation carried out by computer 101 when printing system 100 is calibrated for a lesser degree of underlap (i.e., a lesser degree of underlap than print operation 600) and/or a faster printing and processing speed.

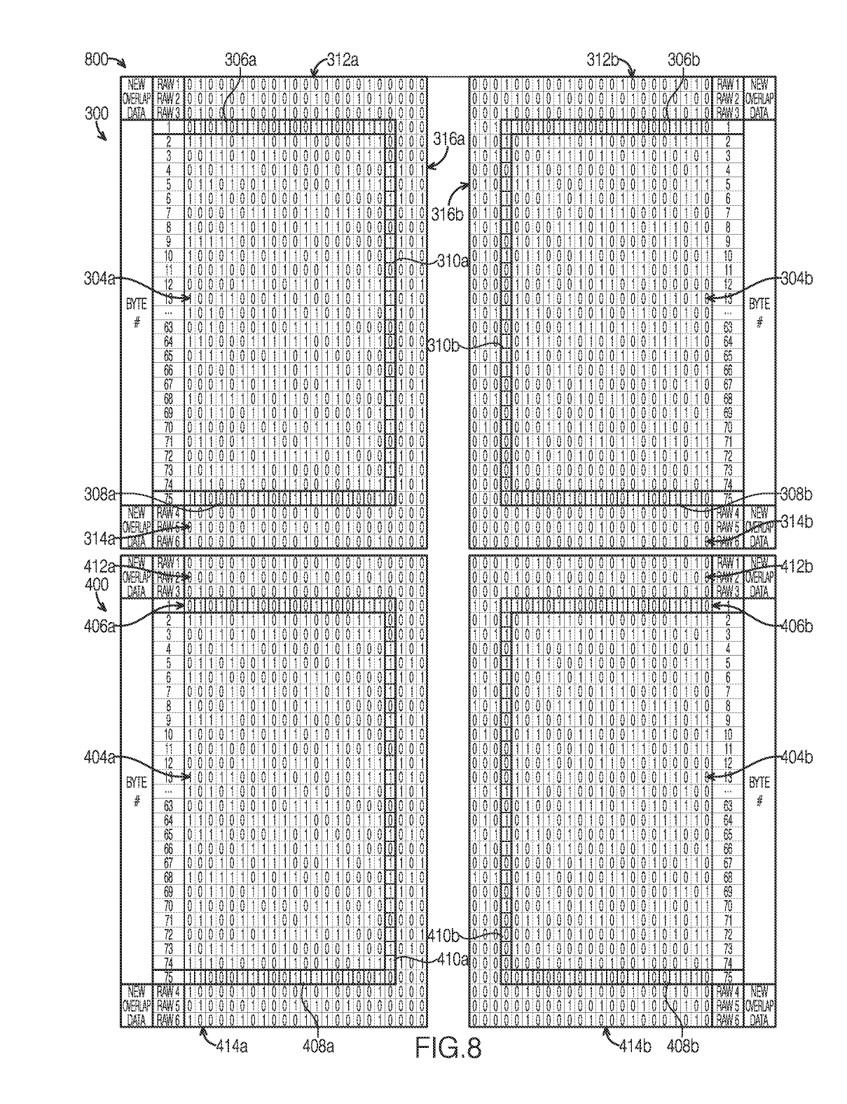

Another example where a portion of the perimeter print area graphical data is replicated, while the remaining perimeter print area graphical data is non-replicated is shown in FIG. 8 including graphical data for a third example print operation 800. In print operation 800, perimeter print area graphical data is replicated in boundary print areas for each perimeter print area pixel position, however, boundary print area graphical data is reduced by selectively replicating in the three rows/columns of boundary pixel positions.

Similarly to print operations 600 and 700, print operation 800 includes first print pass 300 and second print pass 400. Like print operation 600, perimeter graphical data in perimeter print areas of print operation 800 is replicated in the row/columns of boundary print area pixel positions aligned with each perimeter pixel positions. Differently from print operation 600, perimeter graphical data is not copied in all three corresponding boundary pixel positions. Instead, perimeter graphical data for every other pixel position is directly replicated in the corresponding rows/columns of boundary print area pixel positions aligned with the perimeter pixel positions.

Specifically, in one example, longitudinal perimeter print area 308a includes graphical data “110001110011111010010”. The graphical data shown in longitudinal perimeter print area 308a is replicated for each pixel position in an alternating manner in the corresponding three rows of pixel positions in longitudinal boundary area 314a. More specifically, for every “1” indicated in the perimeter graphical data it is alternatingly replicated in a first row (i.e., RAW 1) and a third row (i.e., RAW3) boundary graphical data and in a second row of boundary graphical data. Non-replicated pixel positions are automatically assigned a “0”. Accordingly, the first and third rows include the graphical data “10000101000101000010”, while the second row includes the graphical data “010000100010100100000”.

In the present example, the first pixel position of the first and third rows in the boundary print area is a replicated position and the first pixel position in the second row in the boundary print area is a non-replicated position. It will be appreciated that in other examples the first position in the second row can instead be a replicated position and the first pixel position in the first and third rows can be a non-replicated position.

In another example shown in FIG. 8, longitudinal perimeter print area 406a includes graphical data “01010110010011001110”. The graphical data shown in longitudinal perimeter print area 308a is replicated for each pixel position in an alternating manner in the corresponding three rows of pixel positions in longitudinal boundary area 412a. More specifically, for every “1” indicated in the perimeter graphical data it is alternatingly replicated in a first row (i.e., RAW 1) and a third row (i.e., RAW3) boundary graphical data and in a second row of boundary graphical data. Non-replicated pixel positions are automatically assigned a “0”. Accordingly, the first and third rows include the graphical data “010001000100010001000100”, while the second row includes the graphical data “00010010000010001010”.

In some examples, the pixels of the perimeter print areas are printed at a substantially similar intensity (i.e., coloration) in the boundary print area. In alternate examples, where printing system 100 includes a thermal printer, the pixels of the perimeter boundary area pixels can be printed at outwardly decreasing intensities, thereby outwardly feathering the boundary print area. It will be appreciated that although not specifically described, graphical data for other boundary print areas of print operation 800 is generated in a substantially similar matter as described above in reference to boundary print areas 314a and 412a.

In the example of graphical data for print operation 800, longitudinal boundary areas 314a and 412a are overlapping longitudinal boundary areas that include replicated perimeter print area graphical data. Therefore, the perimeter graphical data and resulting image is alternatingly replicated a three pixel width distance outside of the main print area. Accordingly, a condition of underlap can be corrected via print operation 800 and graphical data of print operation 800 results from a calculation carried out by computer 101 when printing system 100 is calibrated for a lesser degree of underlap (i.e., a lesser degree of underlap than print operation 600) and/or a faster printing and processing speed.

It will be appreciated that the example graphical data sets shown in FIGS. 6-8 are represent a small subset of the possible graphical data generated by computer 101. Other example techniques for replicating perimeter print area graphical data in a corresponding boundary print area include but are not limited to: replicating perimeter print area graphical data in only the first row/column of the boundary print area, replicating perimeter print area graphical data in only the first and second rows/columns of the boundary print area, replicating perimeter print area graphical data in one, two, or three rows/columns of the boundary print area for every third perimeter pixel position, replicating perimeter print area graphical data in one, two, or three rows/columns of the boundary print area for every fourth perimeter pixel position, etc.

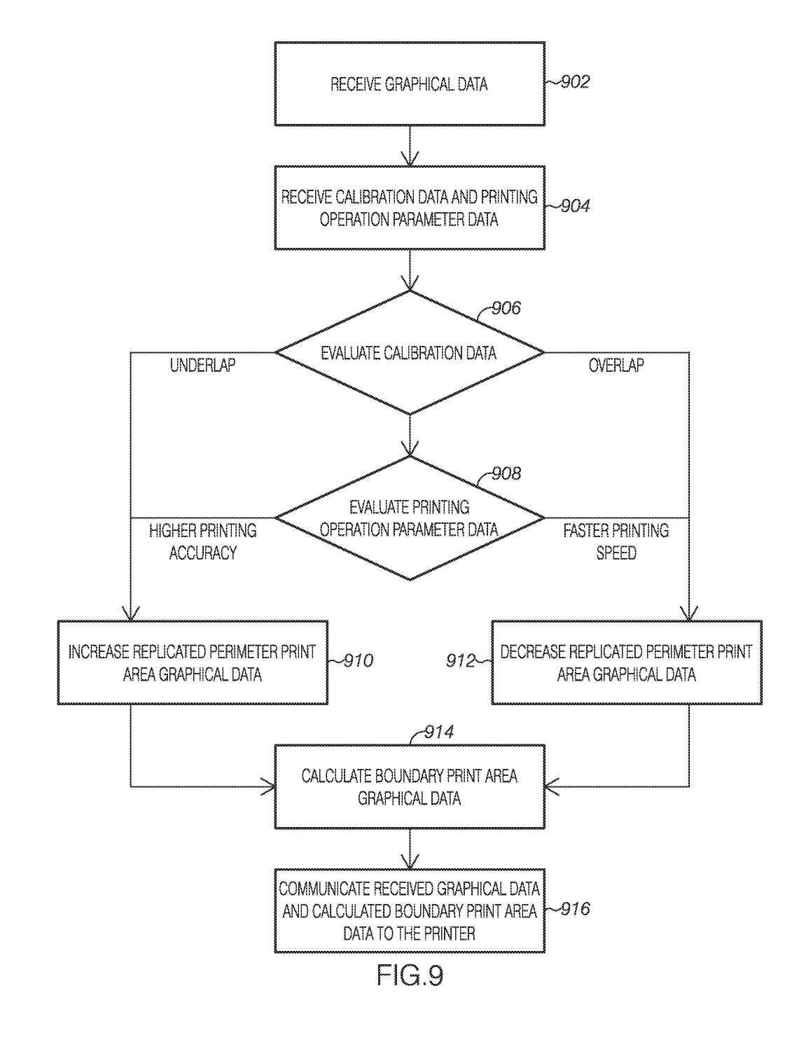

Turning attention to FIG. 9, a method 900 of using printing system 100 will now be described. Method 900 includes receiving graphical data, calibration data (e.g., a higher degree of underlap, a lesser degree of underlap, a higher degree of overlap, a lesser degree of overlap, etc.), and desired printing operation parameters (e.g., a faster printing speed, a higher accuracy print operation, reduced energy consumption, etc.). Based on the calibration data and desired printing operation parameters, the computer calculates/generates graphical data for the boundary print areas from the perimeter graphical data. The printing operation is then performed to produce a desired image (i.e., an image corresponding to the received graphical data). It will be appreciated that system memory 107 of computer 101 includes non-transitory computer-readable instructions for carrying out the steps of method 900.

As shown in FIG. 9, at step 902, computer 101 receives graphical data for a printing operation. Graphical data can be directly input by a user, input by a user via an external memory location, or automatically received from an external memory location. At step 904, computer 101 received calibration data and/or desired printing operation parameter data. As described above, calibration data can be input by the user and/or automatically detected via sensors within printer 200. Printing operation parameters can be input by the user or the printing operation parameter can be pre-set parameters. It will be appreciated that in alternate examples steps 902 and 904 can be performed simultaneously or step 904 can be performed before step 902.

After receiving the various data described above, computer 101 evaluates the calibration data to evaluate if there is a condition of underlap or overlap at step 906. Further, computer 101 evaluates printing operation parameter data to evaluate if a faster printing speed or a higher accuracy is desired at step 908. If a condition of underlap and/or higher accuracy printing is determined, computer 101 increases a number of replicated perimeter print area pixel positions (step 910). Additionally or alternatively, if a condition of overlap and/or a faster printing speed is determined, computer 101 decreases a number of replicated perimeter print area pixel positions (step 912).

At step 914, computer 101 then calculates the boundary print area graphical data from the perimeter print area graphical data. Lastly, computer 101 communicates the received graphical data and the calculated boundary print area data to printer 200 for printing of the image on the printing substrate (i.e., performing of a printing operation).

During the printing operation, the printer prints a first print pass on the printing substrate, the first pass having a first main print area with a first perimeter print area corresponding to a first set of main print area graphical data and a first longitudinal boundary area corresponding to a first set of longitudinal boundary graphical data. The printer then prints a second main print area with a second perimeter print area corresponding to a second set of main print area graphical data and a second longitudinal boundary area corresponding to a second set of boundary graphical data. The first longitudinal boundary area and the second longitudinal boundary area are an at least partially overlapping longitudinal boundary area. The longitudinal boundary area data is generated by the computer to result in an even blending of the overlapping longitudinal boundary area, which lies between the adjacent first and second print passes. It will be appreciated that in examples having two printer heads, lateral boundary areas can be blended in a substantially similar manner.

It will be appreciated that in other examples the method for using printing system can include more or fewer steps. For example, receiving printing parameter data can be excluded from the method and, accordingly, printing parameter data can then be excluded from the evaluation and calculation of boundary print area graphical data. In another example, the method can include the additional step of after receiving and assessing print data, manually adjusting the boundary print area to include more or fewer columns and/or to adjust the status of a pixel position as desired by the user.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A printing system, comprising:
at least one printing mechanism capable of making a plurality of print passes on a printing substrate in order to produce an image on the printing substrate, the plurality of print passes having a plurality of at least partially overlapping boundary areas between adjacent passes in the plurality of print passes; and
a computing system, the computing system being at least a processor and a non-transitory computer-readable storage medium, the non-transitory computer-readable storage medium having computer-readable instructions for:
receiving calibration data,
receiving graphical data,
generating a first set of perimeter data based on the graphical data,
generating a first set of boundary data by:
replicating only a portion of the first set of perimeter data to the first set of boundary data, and
infilling the remainder of the first set of boundary data with blank data,
printing a first print pass on the printing substrate, the first pass including a first boundary area corresponding to the first set of boundary data,
generating a second set of perimeter data based on the graphical data,
generating a second set of boundary data by:
replicating only a portion of the second set of perimeter data to the second set of boundary data, and
infilling the second set of boundary data with blank data,
printing a second print pass on the printing substrate, the second pass including a second boundary area corresponding to the second set of boundary data, wherein the second boundary area at least partially overlaps the first.

2. The printing system of claim 1, wherein the graphical data further comprises a first set of main print area graphical data, and
the first print pass further comprises a first main print area corresponding to the first set of main print area graphical data, the first perimeter print area being a perimeter of the first main print area, the first boundary area being adjacent to the first perimeter print area outside of the first main print area.

3. (canceled)

4. The printing system of claim 1, wherein the graphical data further comprises a second set of main print area graphical data, and
the second print pass further comprises a second main print area corresponding to the second set of main print area graphical data, the second perimeter print area being a perimeter of the second main print area, the second boundary area being adjacent to the second perimeter print area outside of the second main print area.

5. The printing system of claim 1, wherein the blank data of the first set of boundary data complements the blank data of the second set of boundary data, thereby visually blending the first boundary area and the second boundary area.

6. The printing system of claim 5, wherein the first perimeter print area and the second perimeter print area each comprise one or more rows of perimeter pixel positions, and
the first boundary area and the second boundary area each comprise one or more rows of boundary pixel positions.

7. The printing system of claim 6, wherein the calibration data comprises a calibration for overlap between the first print pass and the second print pass.

8. The printing system of claim 7, wherein generating the first set of boundary graphical data and generating the second set of boundary graphical data comprises decreasing a number of pixels to be printed in the one or more rows of boundary pixel positions relative to a number of pixels to be printed in the one or more rows of perimeter pixel positions from the perimeter boundary data.

9. The printing system of claim 6, wherein the calibration data comprises a calibration for underlap between the first print pass and the second print pass.

10. The printing system of claim 9, wherein the one or more rows of perimeter pixel positions comprises one row of perimeter pixel positions, and
generating the first set of boundary graphical data and generating the second set of boundary graphical data comprises copying a number of pixels to be printed in the one row of perimeter pixel positions from the perimeter boundary data and identically replicating the one row of perimeter pixel positions in each of the one or more rows of boundary pixel positions.

11. The printing system of claim 9, wherein the one or more rows of perimeter pixel positions comprises one row of perimeter pixel positions, and
generating the first set of boundary graphical data and generating the second set of boundary graphical data comprises copying a number of pixels to be printed in the one row of perimeter pixel positions from the perimeter boundary data and replicating the one row of perimeter pixel positions with outwardly decreasing intensity in each of the one or more rows of boundary pixel positions.

12. The printing system of claim 9, wherein the one or more rows of perimeter pixel positions comprises one row of perimeter pixel positions, and
generating the first set of boundary graphical data and generating the second set of boundary graphical data comprises copying a number of pixels to be printed in the one row of perimeter pixel positions at a selected interval from the perimeter boundary data and replicating the one row of perimeter pixel positions at the selected interval in each of the one or more rows of boundary pixel positions.

13. The printing system of claim 1, wherein the at least one printing mechanism comprises a first printing mechanism and a second printing mechanism, the plurality of print passes further having a plurality of at least partially overlapping lateral boundary areas between aligned passes in the plurality of print passes, and
the non-transitory computer-readable storage medium has further computer-readable instructions for:
generating graphical data, the graphical data being at least the first set of perimeter data to be printed by the first printing mechanism and a second set of perimeter data to be printed by the second printing mechanism,
generating a first set of lateral boundary data according to the first set of perimeter data and the calibration data,
generating a second set of lateral boundary data according to the second set of perimeter data and the calibration data,
printing the first print pass on the printing substrate, the first pass having at least the first perimeter print area corresponding to the first set of perimeter data and a first lateral boundary area corresponding to the first set of lateral boundary data, the first lateral boundary area being adjacent to a first lateral edge of the first perimeter print area,
printing a second print pass on the printing substrate, the second print pass having at least a second perimeter print area corresponding to the second set of perimeter data and a second lateral boundary area corresponding to the second set of lateral boundary data, the second lateral boundary area being adjacent to a first lateral edge of the second perimeter print area, and
blending the first lateral boundary area with the second lateral boundary area to generate a first at least partially overlapping lateral boundary area.

14. A printing system, comprising:
at least one printing mechanism capable of making a plurality of print passes on a printing substrate in order to produce an image on the printing substrate, the plurality of print passes having a plurality of at least partially overlapping boundary areas between adjacent passes in the plurality of print passes; and
a computing system, the computing system being at least a processor and a non-transitory computer-readable storage medium, the non-transitory computer-readable storage medium having computer-readable instructions for:
receiving calibration data,
receiving graphical data,
generating a first set of perimeter data and a second set of perimeter data based on the graphical data,
generating a first set of boundary data by:
replicating only a portion of the first set of perimeter data to the first set of boundary data, and
infilling the remainder of the first set of boundary data with blank data,
generating a second set of boundary data by:
replicating only a portion of the second set of perimeter data to the second set of boundary data, and
infilling the remainder of the second set of boundary data with blank data,
printing a first print pass on the printing substrate, the first pass having at least a first perimeter print area corresponding to the first set of perimeter data and a first longitudinal boundary area corresponding to the first set of boundary data, the first longitudinal boundary area being adjacent to a first longitudinal edge of the first perimeter print area,
printing a second print pass on the printing substrate, the second pass having at least a second perimeter print area corresponding to the second set of perimeter data and a second boundary area corresponding to the second set of boundary data, the second longitudinal boundary area being adjacent to a first edge of the second perimeter print area, and
blending the first boundary area and the second boundary area to generate a first at least partially overlapping longitudinal boundary area.

15. The printing system of claim 14, wherein the first perimeter print area and the second perimeter print area each comprise one or more rows of perimeter pixel positions, and
the first boundary area and the second boundary area each comprise one or more rows of boundary pixel positions.

16. The printing system of claim 15, wherein the calibration data comprises a calibration for overlap between the first print pass and the second print pass, and
generating the first set of boundary graphical data and generating the second set of boundary graphical data comprises decreasing a number of pixels to be printed in the one or more rows of boundary pixel positions relative to a number of pixels to be printed in the one or more rows of perimeter pixel positions from the perimeter boundary data.

17. The printing system of claim 15, wherein the calibration data comprises a calibration for underlap between the first print pass and the second print pass,
the one or more rows of perimeter pixel positions comprises one row of perimeter pixel positions, and
generating the first set of boundary graphical data points and generating the second set of boundary graphical data points comprises copying a number of pixels to be printed in the one row of perimeter pixel positions from the perimeter boundary data and identically replicating the one row of perimeter pixel positions in each of the one or more rows of boundary pixel positions.

18. The printing system of claim 15, wherein the calibration data comprises a calibration for underlap between the first print pass and the second print pass,
the one or more rows of perimeter pixel positions comprises one row of perimeter pixel positions,
generating the first set of boundary data and generating the second set of boundary data comprises copying a number of pixels to be printed in the one row of perimeter pixel positions from the perimeter boundary data and replicating the one row of perimeter pixel positions with outwardly decreasing intensity in each of the one or more rows of boundary pixel positions.

19. The printing system of claim 15, wherein the calibration data comprises a calibration for underlap between the first print pass and the second print pass,
the one or more rows of perimeter pixel positions comprises one row of perimeter pixel positions, and
generating the first set of boundary data and generating the second set of boundary data comprises copying a number of pixels to be printed in the one row of perimeter pixel positions at a selected interval from the perimeter boundary data and replicating the one row of perimeter pixel positions at the selected interval in each of the one or more rows of boundary pixel positions.

20. A printing system, comprising:
at least one printing mechanism capable of making a plurality of print passes on a printing substrate in order to produce an image on the printing substrate, the plurality of print passes having a plurality of at least partially overlapping boundary areas between adjacent passes in the plurality of print passes; and
a computing system, the computing system being at least a processor and a non-transitory computer-readable storage medium, the non-transitory computer-readable storage medium having computer-readable instructions for:
receiving calibration data,
receiving graphical data,
generating a first set of perimeter data and a second set of perimeter data,
generating a first set of boundary data by:
replicating only a portion of the first set of perimeter data to the first set of boundary data, and
infilling the remainder of the first set of boundary data with blank data,
generating a second set of boundary data by:
replicating only a portion of the second set of perimeter data to the second set of boundary data, and
infilling the remainder of the second set of boundary data with blank data,
printing a first print pass on the printing substrate, the first pass having at least a first perimeter print area corresponding to the first set of perimeter data and a first boundary area corresponding to the first set of boundary data, the first boundary area being adjacent to a first longitudinal edge of the first perimeter print area,
printing a second print pass on the printing substrate, the second pass having at least a second perimeter print area corresponding to the second set of perimeter data and a second boundary area corresponding to the second set of boundary data, the second boundary area being adjacent to a first longitudinal edge of the second perimeter print area, and
blending the first longitudinal boundary area and the second longitudinal boundary area to generate a first at least partially overlapping longitudinal boundary area,
wherein the calibration data has one of a calibration for underlap between the first print pass and the second print pass and a calibration for overlap between the first print pass and the second print pass.

21. The printing system of claim 1, wherein the blank data of the first and second sets of overlapping boundary data correspond to unprinted pixels on the printing substrate.
